(19) United States
(12) Patent Application Publication
(10) Pub. No.: US 2006/0035688 A1
(43) Pub. Date: Feb. 16, 2006

(54) Cell phone accessory

(76) Inventors: Saraa C. Paho, Sterling Heights, MI (US); David D. Yeldo, West Bloomfield, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/916,891

(22) Filed: Aug. 12, 2004

(51) Int. Cl. H04M 1/00

(52) U.S. Cl. 455/575.2; 455/550.1

(57) ABSTRACT

A cellular telephone headset according to the present invention provides a remote caller-id display near the microphone. When an incoming call is received, the user can decide whether the answer the call based upon the information displayed on the remote caller-id display. The user does not have to remove the cellular telephone from the user's pocket or clip in order to view the caller-id information. The user can also handle the call using buttons on the headset microphone. The headset of the present invention is therefore much more convenient to use in a truly hands-free many.

### BACKGROUND OF THE INVENTION

This invention relates to cellular telephones and more particularly to an accessory for a cellular telephone.

Cellular telephones have been widely adopted and have become indispensable for many users. Frequent users, especially those who need to conduct business on their cellular telephone while working, driving, or otherwise using their hands often use headsets connected to their cellular telephone. The headset provides an earpiece and a microphone that can be used hands-free. The headset may be connected to the cellular telephone via a wire or wirelessly, such as via Bluetooth, while the cellular telephone itself is in the user's pocket or on a belt clip, etc.

The hands-free headsets are convenient while talking. However, when a second incoming call is received while the user is on a first call, the user must either answer the second incoming call blindly or look at the caller-id display on the cellular telephone. Since the cellular telephone is in the user's pocket or clip, the operation is no longer hands-free.

### SUMMARY OF THE INVENTION

A cellular telephone headset according to the present invention provides a remote caller-id display near the microphone. When an incoming call is received, the user can decide whether the answer the call based upon the information displayed on the remote caller-id display. The user does not have to remove the cellular telephone from the user's pocket or clip in order to view the caller-id information. The user can also handle the call using buttons on the headset microphone.

The headset of the present invention is therefore much more convenient to use in a truly hands-free many. Even when handling multiple calls, such as with call-waiting or with multiple lines, the user does not need to operate the cellular telephone.

### BRIEF DESCRIPTION OF THE DRAWINGS

Other advantages of the present invention can be understood by reference to the following detailed description when considered in connection with the accompanying drawings wherein:

FIG. 1 illustrates the cell phone accessory according to one embodiment of the present invention.

### DETAILED DESCRIPTION OF THE PREFERRED EMBODIMENT

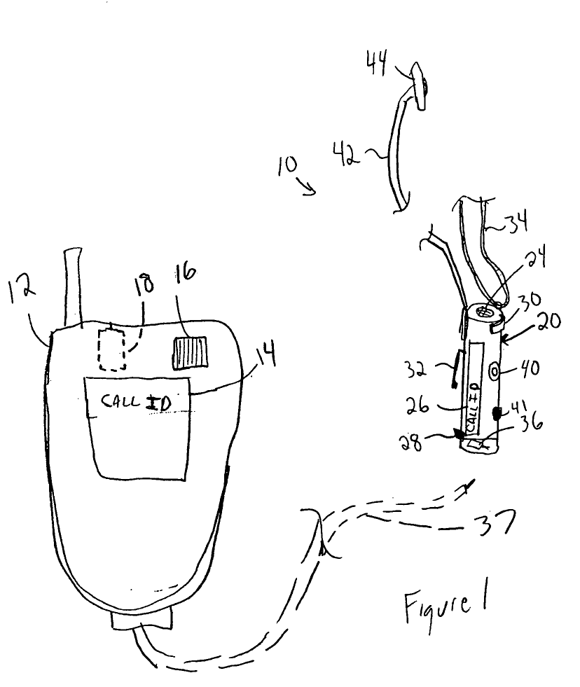

A cellular telephone headset 10 according to the present invention is shown in FIG. 1 connected to a cellular telephone 12. The cellular telephone 12, as is common, has a caller-id display 14 and a built-in CCD camera 16. The camera 16 may be used, for example, to associate pictures of likely callers to their caller-id information, so that their picture may be displayed along with their caller-id information on the caller-id display 14. The cellular telephone 12 may further includes a wireless transceiver 18, such as Bluetooth, for wirelessly communicating with the headset 10.

The headset 10 provides remote operation of the cellular telephone 12, as will be described. The headset 10 generally includes a lower module 20 having a housing 22. A microphone 24 is formed in the housing 22 of the lower module 20 to capture the sound of the user's voice when on a call. The lower module 20 further includes a caller-id display 26. The caller-id display 26 may be an LCD display for displaying the name, number or name and number of an incoming caller to cellular telephone 12.

The lower module 20 includes an on/off switch 28 for selectively powering the headset 10 (battery not shown). The lower module 20 also includes a switch 30 for answer calls, hanging up, switching between multiple telephone calls or lines or call-waiting. Other call-handling features may also be provided on lower module 20.

The lower module 20 may include a clip 32 for clipping the lower module 20 to the user's shirt (for example). Alternatively, or in addition, the lower module 20 may be connected to a light chain 34 for wearing around the user's neck. A connection is provided between the headset 10 and the cellular telephone 12, which may be a wireless transceiver 36 built into lower module 20, and/or a wire 37 connected directly to the cellular telephone 12. The wireless transceiver 36 is complementary to the wireless transceiver 18 on the cellular telephone 12, such as Bluetooth.

The lower module 20 may optionally include a camera 40, such as a CCD camera and lens, and a switch 41 for activating the camera 40 to take a picture. The camera 40 sends images it captures to the cellular telephone 12 for storage and for use in supplementing caller-id information, etc. The lower module 20 is connected via a wire 42 to an earpiece 44, which may be similar to known earpieces.

In operation, when an incoming call is received by cellular telephone 12, the caller-id information is sent (wirelessly via transceivers 18 and 36, or over wire 37) to the lower module 20 of the headset 10. The caller-id information is displayed on the caller-id display 26 where it is easily viewed by the user, who does not need to take the cellular telephone 12 out of the user's pocket or clip. If the user chooses to answer the incoming call, the user activates the switch 30 to answer the call. The sound from the call is transmitted from the cellular telephone 12 to the earpiece 44 on the headset 10, while sound is transmitted to the cellular telephone 12 from the microphone 24 on the lower module 20.

If a second incoming call is received during the first incoming call, the caller-id information from the second incoming call is transmitted to the lower module 20 and displayed on the caller-id display 26. The user can view this caller-id information easily, again without removing the cellular telephone 12 from a pocket or clip. The user can also answer the second incoming call via switch 30. As shown, the headset 10 of the present invention provides a more convenient operation and call handling, especially with regard to caller-id information.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A cellular telephone headset comprising:
an earpiece;
a microphone;
a caller-id display; and
a connection for communicating to a cellular telephone, including providing sound from a call to the earpiece, providing sound to the call from the microphone and providing caller-id information from the call to the caller-id display.

2. The headset of claim 1 wherein the connection includes a wire.

3. The headset of claim 1 wherein the connection includes a wireless transceiver.

4. The headset of claim 1 further including a lower housing, the microphone and the caller-id display mounted in the lower housing.

5. The headset of claim 4 wherein the earpiece is connected to the lower housing via a wire.

6. The headset of claim 5 wherein the connection is in the lower housing.

7. The headset of claim 6 wherein the connection includes a wireless transceiver.

8. The headset of claim 4 further including a camera mounted in the lower housing, the camera sending images to the cellular telephone via the connection.

9. A cellular telephone headset comprising:
a lower module;
a microphone mounted in the lower module;
a caller-id display mounted in the lower module
an earpiece remote from the lower module and connected to the lower module; and
a connection for communicating to a cellular telephone, including providing sound from a call to the earpiece, providing sound to the call from the microphone and providing caller-id information from the call to the caller-id display.

10. The headset of claim 9 wherein the connection includes a wire.

11. The headset of claim 9 wherein the connection includes a wireless transceiver.

12. The headset of claim 9 wherein the earpiece is connected to the lower housing via a wire.

13. The headset of claim 9 wherein the connection is in the lower module.

14. The headset of claim 6 wherein the connection includes a wireless transceiver.

15. The headset of claim 9 further including a camera mounted in the lower module, the camera sending images to the cellular telephone via the connection.

16. The headset of claim 9 connected to a cellular telephone, wherein the microphone sends sound to the call on the cellular telephone, the earpiece receives sound from the call on the cellular telephone and the cellular telephone provides caller-id information to the caller-id display.

17. The headset of claim 9 wherein the lower module further include at least one switch for handling phone calls.

18. A method for receiving a cellular telephone call including the steps of:
a) receiving caller-id information at a cellular telephone;
b) transmitting the caller-id information to a remote module, remote from the cellular telephone;
c) displaying the caller-id information at the remote module;
d) sending sound from the call from the cellular telephone to the remote module; and
e) relaying sound from the remote module to the call at the cellular telephone.

19. The method of claim 18 wherein the caller-id information and sound is transmitted to the remote module wirelessly.

20. The method of claim 18 wherein the remote module is a headset including a microphone and an earpiece.
